(19) United States
(12) Patent Application Publication
(10) Pub. No.: US 2014/0106711 A1
(43) Pub. Date: Apr. 17, 2014

(54) METHOD, USER DEVICE AND COMPUTER-READABLE STORAGE FOR DISPLAYING MESSAGE USING FINGERPRINT

(71) Applicants: CRUCIALSOFT COMPANY, Seoul (KR); CRUCIALTEC CO., LTD., Chungcheongnam-do (KR)

(72) Inventors: Jong Chul SEO, Gyeonggi-do (KR); Hyo Min JOO, Gyeonggi-do (KR)

(73) Assignees: CRUCIALSOFT COMPANY, Seoul (KR); CRUCIALTEC CO., LTD., Chungcheongnam-do (KR)

(21) Appl. No.: 14/045,951

(22) Filed: Oct. 4, 2013

(30) Foreign Application Priority Data
Oct. 4, 2012 (KR) 10-2012-0110163

(51) Int. Cl. H04L 29/06; H04W 12/06

(52) U.S. Cl. CPC H04L 63/0861; H04W 12/06
USPC 455/411

(57) ABSTRACT

Provided are a method of displaying a message using a fingerprint, a user terminal, and a recording medium. The method includes displaying message reception notification of a received message in a screen lock state, sensing an input fingerprint so as to confirm the received message, and displaying the message while maintaining the screen lock state when the sensed fingerprint is authenticated.

### CROSS-REFERENCE TO RELATED APPLICATION

This application claims priority to and the benefit of Korean Patent Application No. 2012-110163, filed on Oct. 4, 2012, the disclosure of which is incorporated herein by reference in its entirety.

### BACKGROUND

1. Field of the Invention

The present invention relates to a method of displaying a message, a user terminal, and a recording medium, and more particularly, to a method of displaying a message using a fingerprint, a user terminal, and a recording medium.

2. Discussion of Related Art

In recent years, various additional functions utilizing personal information such as mobile banking have been provided through mobile communication terminals in addition to communication functions such as phone services or text message transmission services.

Thus, there is an urgent need for a lock device for the mobile communication terminal.

Most existing lock devices applied to the mobile communication terminals perform typical methods using passwords.

For example, in a typical method, the lock device is applied to a phone function, an additional function, an international calling function, or the like, and a corresponding password should be input in order to use the corresponding function.

However, there are disadvantages in that the method is useless when the password is exposed, the password should be regularly changed in order to ensure stability, a user should remember the password, and the like.

Thus, in recent years, in order to supplement the above-described method and improve locking effects, a terminal in which a lock device using fingerprint recognition is mounted has been developed in earnest.

In order for such a fingerprint recognition apparatus to be mounted in a mobile communication terminal which is manufactured to be small, a size of a corresponding sensor should be minimized. In accordance with this need, a “sliding type” fingerprint recognition sensor that recognizes a fingerprint when a corresponding finger is swiped on a sensor which is provided in the form of a laterally long bar has been developed.

Meanwhile, as fingerprint recognition sensors come to be mounted on mobile communication terminals, efforts to graft other functions onto the fingerprint recognition sensor are being made.

### SUMMARY

The present invention is directed to a method of displaying a received message while maintaining a screen lock state through fingerprint authentication, a user terminal, and a recording medium.

According to an aspect of the present invention, there is provided a method in which a user terminal displays a message using a fingerprint, including: displaying message reception notification of a received message in a screen lock state; sensing an input fingerprint so as to confirm the received message; and displaying the message while maintaining the screen lock state when the sensed fingerprint is authenticated.

Here, the displaying of the message may include displaying one portion or the entire portion of the message.

According to another aspect of the present invention, there is provided a computer-readable recording medium in which a program for executing the above-described method is recorded.

According to still another aspect of the present invention, there is provided a user terminal which displays a message using a fingerprint, including: a message reception notifying unit that displays message reception notification of a received message in a screen lock state; a fingerprint sensor unit that senses an input fingerprint so as to confirm the received message; and a message displaying unit that displays the message while maintaining the screen lock state when the sensed fingerprint is authenticated.

Here, the message displaying unit may display one portion or the entire portion of the message.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 illustrates a structure of a user terminal according to an embodiment of the present invention;

FIG. 2 illustrates an example of a fractional fingerprint image obtained by a sliding fingerprint sensor unit shown in FIG. 1;

FIG. 3 is a block diagram illustrating a configuration of a user terminal according to an embodiment of the present invention;

FIG. 4 is a flowchart illustrating a process of displaying a message using a fingerprint according to an embodiment of the present invention; and

FIG. 5 illustrates a method of displaying a message using a fingerprint according to an embodiment of the present invention.

### DETAILED DESCRIPTION OF EXEMPLARY EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as being limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Hereinafter, embodiments of the present invention will be described in detail with reference to the accompanying drawings.

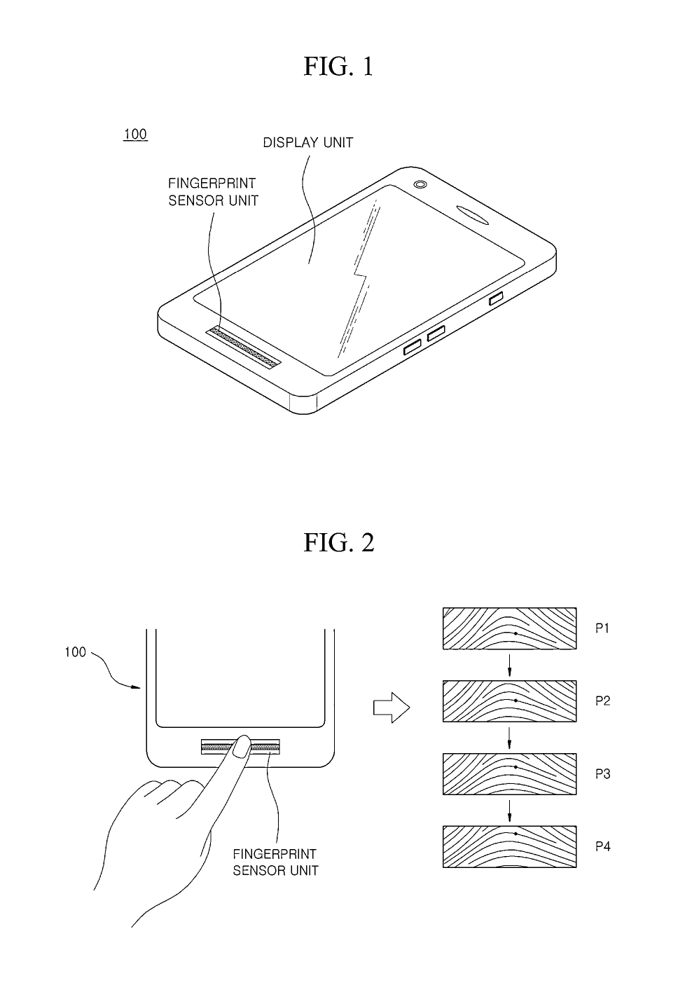

FIG. 1 illustrates a structure of a user terminal 100 according to an embodiment of the present invention.

Referring to FIG. 1, a user terminal 100 according to an embodiment of the present invention may include a fingerprint sensor unit in at least a portion thereof.

In FIG. 1, a case in which the fingerprint sensor unit is formed in a side edge of the user terminal 100 is shown, but the fingerprint sensor unit can be formed in any position without departing from the scope of the present invention.

The user terminal 100 according to an embodiment of the present invention may be a digital device that performs a user's desired operation by performing predetermined data processing.

In addition, the user terminal 100 may include an input unit and a display unit, and provide a state with respect to an operation performed by a predetermined operation instruction of the user through the input unit to the user through the display unit.

In FIG. 1, an example in which the display unit of the user terminal 100 is implemented in a touch screen method and the display unit itself simultaneously acts as the input unit is illustrated, but the input unit may be implemented in, for example, a keyboard or keypad method and provided separately from the display unit.

The user terminal 100 according to an embodiment of the present invention should be understood as an encompassing term including digital devices which include a memory means performed in a touch screen method and have a microprocessor mounted therein for computing power, such as tablet PCs, smart phones, PDAs, web pads, mobile phones, navigation systems, digital cameras, and the like.

In addition, the user terminal 100 according to another embodiment of the present invention should be understood as an encompassing term including devices in which a separate fingerprint recognition device is connected to a personal computer (PC), a workstation, or the like.

The fingerprint sensor unit according to an embodiment of the present invention may be implemented as a sliding type. The sliding type fingerprint sensor unit performs fingerprint recognition in such a manner that fragmentary fingerprint images are read by sensing a fingerprint of a finger which slidably moves and then the read fragmentary fingerprint images are matched to a single image to implement a complete fingerprint image.

FIG. 2 illustrates an example of fractional fingerprint images obtained by a sliding fingerprint sensor unit shown in FIG. 1.

For example, when a user slidably moves his or her thumb on the fingerprint sensor unit, partial fractional images P1 to P4 are consecutively obtained.

That is, fingerprint images of the user are sequentially obtained in a fractional but mutually consecutive manner.

The fractional fingerprint images read from the fingerprint sensor unit are matched to a single fingerprint image.

According to an embodiment, the matched fingerprint image is compared with a fingerprint image registered in advance, and is used as a means for confirming the authenticity of the user.

That is, user authentication may be performed in such a manner that the registered fingerprint image of the user may be stored in a database (not shown) of the user terminal 100 and the corresponding fingerprint image obtained by the fingerprint sensor unit may be compared with the registered fingerprint image stored in the database.

According to another embodiment, the matched fingerprint image may be compared with at least one fingerprint image preregistered, and act as an instruction for performing a specific operation.

For example, specific operations are matched with fingerprints of each finger of the user and stored, and when the matched fingerprint image obtained by the fingerprint sensor unit identifies with a fingerprint image of a specific finger, a specific operation matched with this may be performed. This is called a “quick launching” function in the present specification.

For example, the user may perform setting in advance in such a manner that a first application is driven when a thumb fingerprint of a true user is recognized and a second application is driven when an index fingerprint of the user is recognized.

Thereafter, when the user slidably moves his or her thumb on the fingerprint sensor unit 120 and the matched fingerprint image obtained by the fingerprint sensor unit 120 identifies with a thumb fingerprint image preregistered, an operation matched with this, that is, a driving operation of the first application, may be performed.

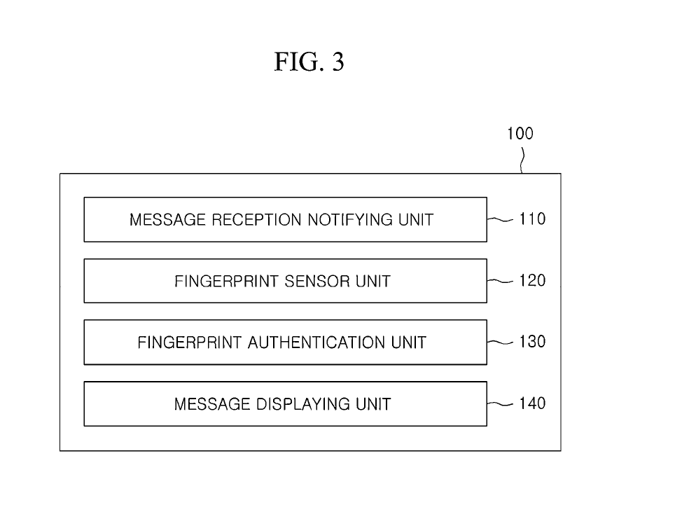

FIG. 3 is a block diagram illustrating a configuration of a user terminal 100 according to an embodiment of the present invention.

The user terminal 100 according to an embodiment of the present invention may include a message reception notifying unit 110, a fingerprint sensor unit 120, a fingerprint authentication unit 130, and a message displaying unit 140.

The message reception notifying unit 110 may display message reception notification on a screen when receiving a message in a screen lock state of the user terminal 100.

In this instance, the message reception notifying unit 110 may display the message reception notification including a user's fingerprint input request for confirming the message.

Here, the message may include at least one of a short message service (SMS) message, a multimedia messaging service (MMS) message, a social network service (SNS) message, and an e-mail, and the message reception notifying unit 110 may enable a type of the received message to be included in the message reception notification and display the message reception notification.

Meanwhile, the fingerprint sensor unit 120 may sense an input fingerprint so as to confirm the message.

Detailed description of fingerprint sensing of the fingerprint sensor unit 120 has been described above and thus will be omitted here.

Meanwhile, the fingerprint authentication unit 130 may perform user authentication by comparing information (hereinafter, referred to as “fingerprint information”) about the fingerprint sensed by the fingerprint sensor unit 120 and preregistered fingerprint information, and for this, a process of registering a fingerprint of the user in advance should be preceded.

For reference, the fingerprint authentication unit 130 may perform user authentication based on fingerprint information of the user preregistered in the user terminal 100, or when the fingerprint information of the user is present in a server (not shown), the fingerprint authentication unit 130 may receive, from the server (not shown), whether the user authentication is performed by transmitting the fingerprint information sensed in the fingerprint sensor unit 120 to the server (not shown).

Hereinafter, a case in which the fingerprint information of the user is preregistered in the user terminal 100 will be described.

Meanwhile, the message displaying unit 140 may display the corresponding message on the screen while maintaining the screen lock state when the fingerprint is authenticated in the fingerprint authentication unit 130.

In this instance, the message displaying unit 140 may display one portion or the entire portion of the corresponding message on the screen, and for this, receive setting about a message display type (one portion or the entire portion) from the user.

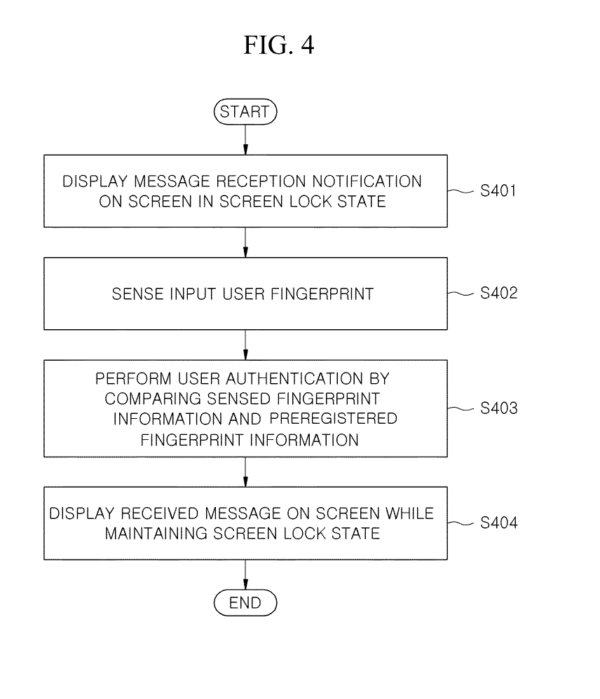

FIG. 4 is a flowchart illustrating a process of displaying a message using a fingerprint according to an embodiment of the present invention.

For reference, the process of displaying the message using the fingerprint shown in FIG. 4 may be performed by the user terminal 100, and a computer-readable recording medium in which a program for executing each operation shown in FIG. 4 is recorded is installed in the user terminal 100, so that each operation shown in FIG. 4 may be executed by the corresponding recording medium.

In addition, in order to use a message display function using the fingerprint of the user terminal 100, the user preregisters his or her fingerprint in the user terminal 100, and the user terminal 100 is currently in a screen lock state.

First, in operation S401, the user terminal 100 receives a message in a screen lock state, and displays message reception notification on a screen.

Here, the message may include at least one of an SMS message, an MMS message, an SNS message, and an e-mail, and a type of the received message and a user's fingerprint input request for confirming the message may be included in the message reception notification.

Next, in operation S402, the user terminal 100 senses an input fingerprint for confirming the received message.

Next, in operation S403, the user terminal 100 performs user authentication by comparing fingerprint information sensed in operation S402 and preregistered fingerprint information.

Next, in operation S404, the user terminal 100 displays the received message on the screen while maintaining a screen lock state.

In this instance, the user terminal may display one portion or the entire portion of the corresponding message in accordance with a message display type set in advance.

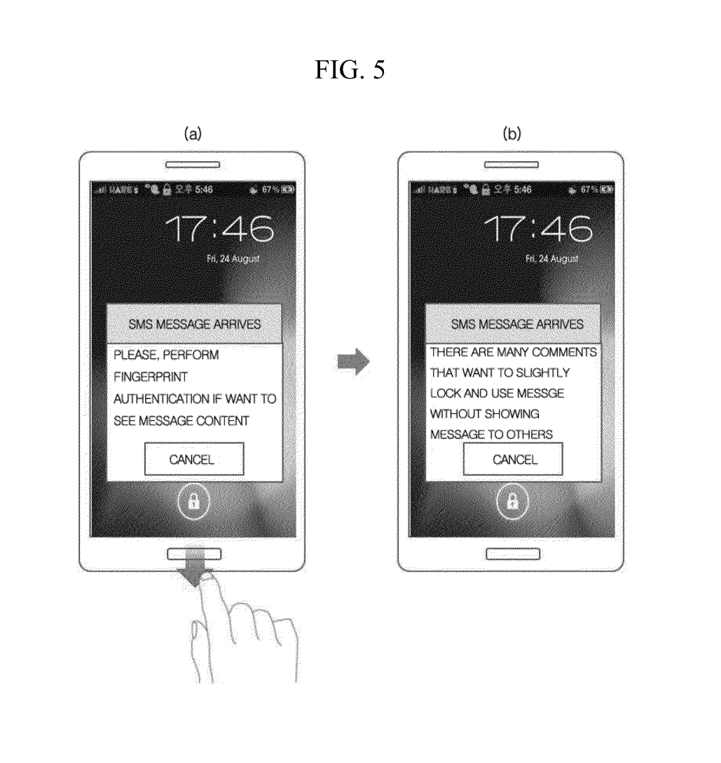

FIG. 5 illustrates a method of displaying a message using a fingerprint according to an embodiment of the present invention.

For reference, in FIG. 5, a user preregisters his or her fingerprint in the user terminal 100, and the user terminal 100 is currently in a screen lock state.

As shown in (a) of FIG. 5, the user terminal 100 which receives a message in the screen lock state may display message reception notification on a screen, and a type of the message and a fingerprint input request may be included in the message reception notification.

Next, when the fingerprint of the user is input, the user terminal 100 may display the corresponding message on the screen while maintaining the screen lock state as shown in (b) of FIG. 5.

In this instance, the user terminal 100 may display one portion or the entire portion of the corresponding message in accordance with a message display type set in advance.

Thus, according to the present invention, it is possible to solve the conventional problem that needs to perform a cumbersome process in order to confirm a corresponding message by displaying a received message on a screen for a predetermined time period when receiving the message in a message lock state, or displaying only whether the message is received. In addition, it is possible to remove a possibility that contents of the received message may be exposed to others, and to directly confirm one portion or the entire portion of the message through fingerprint recognition without performing a cumbersome process.

According to an embodiment of the present invention, it is possible to easily confirm a received message such as an SMS message, an MMS message, an SNS message, an e-mail, and the like while maintaining the screen lock state through fingerprint authentication.

In addition, it is possible to remove a possibility that contents of the message may be exposed to others.

In addition, it is possible to directly confirm a corresponding message without performing a cumbersome process which needs to be performed in order to confirm the message, when receiving the message in the screen lock state.

The effect of the present invention is not limited to the above-described effect, and should be understood to include all effects which can be deduced from the configuration of the invention described in the detailed description or claims of the present invention.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A method in which a user terminal displays a message using a fingerprint, comprising:
displaying message reception notification of a received message in a screen lock state;
sensing an input fingerprint so as to confirm the received message; and
displaying the message while maintaining the screen lock state when the sensed fingerprint is authenticated.

2. The method of claim 1, wherein the displaying of the message includes displaying one portion or the entire portion of the message.

3. A computer-readable recording medium in which a program for executing the method according to claim 1 is recorded.

4. A user terminal which displays a message using a fingerprint, comprising:
a message reception notifying unit that displays message reception notification of a received message in a screen lock state;
a fingerprint sensor unit that senses an input fingerprint so as to confirm the received message; and
a message displaying unit that displays the message while maintaining the screen lock state when the sensed fingerprint is authenticated.

5. The user terminal of claim 4, wherein the message displaying unit displays one portion or the entire portion of the message.

6. A computer-readable recording medium in which a program for executing the method according to claim 2 is recorded.
